(19) United States
(12) Patent Application Publication
(10) Pub. No.: US 2015/0244026 A1
(43) Pub. Date: Aug. 27, 2015

(54) LITHIUM-ION SECONDARY BATTERY AND FORMULA FOR GEL ELECTROLYTE THEREOF

(71) Applicants: NingDe Amperex Technology Limited, Ningde City (CN); DongGuan Amperex Technology Limited, Dongguan (CN)

(72) Inventors: Hui CHEN, Ningde City (CN); Lei NIU, Ningde City (CN); Xinji ZHANG, Dongguan (CN); Hui JIANG, Dongguan (CN)

(21) Appl. No.: 14/620,626

(22) Filed: Feb. 12, 2015

(30) Foreign Application Priority Data
Feb. 27, 2014 (CN) 201410068090.8

(51) Int. Cl. H01M 10/0565; H01M 10/0525

(52) U.S. Cl. CPC H01M 10/0565; H01M 10/0525; H01M 2300/0085

(57) ABSTRACT

The present invention belongs to the technical field of lithium-ion secondary batteries and in particularly relates to a lithium-ion secondary battery and the gel electrolyte formula thereof. The gel electrolyte formula comprises 90-99.4% by weight of a liquid electrolyte, 0.5-3% by weight of a monomer, 0.25-0.6% by weight of a cross-linking agent and 0.1-1.5% by weight of an initiator, wherein the monomer is modified polyvinyl alcohol and the derivates thereof, the average molecular weight of which is 5×10⁴ to 15×10⁴ g/mol. With respect to the prior art, by using modified polyvinyl alcohol and the derivates thereof having a relatively large average molecular weight as the monomer in a gel electrolyte, the present invention forms a polymer substrate having a relatively high mechanical strength so that a cell containing the gel electrolyte is high in mechanical strength and is therefore less swelled in a cycle process.

### FIELD OF THE INVENTION

The present invention belongs to the technical field of lithium-ion secondary batteries and in particular relates to a lithium-ion secondary battery and a formula for the gel electrolyte thereof.

### BACKGROUND OF THE INVENTION

As a very important part of a lithium-ion secondary battery, liquid electrolyte typically consists of lithium salt, an organic solvent and an additive. However, being a flowing liquid, the organic solvent has a potential leakage hazard. Besides, the general use of carbonic ester and carboxylic ester as the organic solvent of a liquid electrolyte leads to a poor high-temperature performance of a battery; moreover, the inherent inflammability of the organic solvent makes the battery potentially explosive.

A great amount of research has been made on polymer electrolyte. As a substitute for liquid electrolyte, polymer electrolyte, with distinct advantages including no liquid leakage, excellent high-temperature performance, high cell hardness and high safety, can meet new industrial requirements on Lithium-ion secondary battery.

The common gel polymer electrolyte used in polymer electrolyte is generally prepared using an in-situ thermal polymerization method in the following way: mix a micromolecular monomer, a liquid electrolyte and an initiator uniformly, inject the mixture into a cell, heat the cell to form a gel so that the micromolecular monomers are cross-linked into a polymer substrate of a network structure under the initiation of the initiator, and trap the liquid electrolyte in the polymer substrate.

However, the gel polymer electrolyte prepared using this method has the following disadvantages: the average molecular weight of the formed polymer substrate is low for the sake of the chain transfer and the chain termination reaction caused by the existence of an solvent during the polymerization process of micromolecular monomers, resulting in a poor bonding between a separator and an electrode material for the low cohesive strength of the generated polymer substrate and a low mechanical strength of a cell which leads to a great swelling of a cell during a cycle process, moreover, residual micromolecules also affect the electrochemical performance of the cell.

Thus, it is indeed necessary to provide a gel electrolyte formula in which a monomer having a relatively large average molecular weight is introduced to prepare a gel electrolyte having a high cohesive strength and to enable a battery containing the electrolyte to meet basic electrochemical performances with superb mechanical strength, excellent cycle performance and a relatively high safety.

### SUMMARY OF THE INVENTION

One of the purposes of the present invention is to address the disadvantages of the prior art with a gel electrolyte formula in which a monomer having a relatively large average molecular weight is introduced to prepare a gel electrolyte of a high cohesive strength.

To achieve the purpose above, the present invention adopts the following technical scheme:

a gel electrolyte formula comprises 90-99.4% by weight of a liquid electrolyte, 0.5-3% by weight of a monomer, 0.25‰-0.6% by weight of a cross-linking agent and 0.1-1.5% by weight of an initiator,

wherein the monomer is modified polyvinyl alcohol and the derivates thereof, the average molecular weight of which is 5×10⁴ g/mol to 15×10⁴ g/mol.

With respect to the prior art, the present invention forms a gel electrolyte by using a modified polyvinyl alcohol having a relatively high average molecular weight and the derivates thereof, which are polymerized under the initiation of an initiator to form a network polymer substrate of a high cohesive strength which is further cross-linked under the cross-linking effect of a cross-linking agent into a three-dimensional network skeleton of a high mechanical strength to trap a liquid electrolyte in the skeleton, as the monomer in the gel electrolyte. As the formed skeleton has a high mechanical strength, a cell containing the gel electrolyte also has a relatively high mechanical strength and is therefore less swelled during a cycle process.

The modified polyvinyl alcohol and the derivates thereof containing a certain hydroxyl, when cross-linked into a network polymer substrate under the initiation of the initiator, form intramolecular hydrogen bonds or extramolecular hydrogen bonds to further increase the cohesive strength of the polymer substrate. Further, with a certain adhesion, the modified polyvinyl alcohol and the derivates thereof are capable of enhancing the interface binding force between the gel electrolyte and the surface of the cathode, the surface of the anode or the separator to inhibit the swelling of the battery during a cycle process. Apparently, the average molecular weight of the modified polyvinyl alcohol and the derivates thereof cannot be too large, otherwise, the solubility and the polymerization activity of the modified polyvinyl alcohol and the derivates thereof are undesirable, on the other hand, the average molecular weight of the modified polyvinyl alcohol and the derivates thereof cannot be too small, otherwise, the chain transfer and the chain termination reaction caused by the existence of the solvent makes it difficult to form a polymer substrate having a relatively high cohesive strength, moreover, residual micromolecules also affect the electrochemical performance of the cell.

If the amount of the added initiator is too small, then the polymerization reaction is incomplete, resulting in an undesirable mechanical performance of the battery, on the other hand, if the amount of the added initial is too large, then the cost is increased, and the electrical performance of the battery is influenced, for example, the capacity of the battery is lowered.

If the amount of the added cross-linking agent is too small, then the cross-linking reaction is incomplete, resulting in an undesirable mechanical performance of the battery, on the other hand, if the amount of the added cross-linking agent is too large, then the cost is increased.

As an improvement of the gel electrolyte formula disclosed herein, the weight percent of each of the aforementioned components is as follows:

liquid electrolyte: 93%-98%;

monomer: 1%-2%;

cross-linking agent: 0.75%0-0.4%; and

initiator: 0.2%-1%. This formula is a preferable one.

As an improvement of the gel electrolyte formula disclosed herein, the average molecular weight of the modified polyvinyl alcohol and the derivates thereof is preferably 8×10⁴ g/mol to 12×10⁴ g/mol.

As an improvement of the gel electrolyte formula disclosed herein, the derivates include at least one of polyvinly acetal, polyvinyl butyral and polyvinyl formal, which are prepared through the aldolization reaction of polyvinyl alcohol with acetaldehyde, butyraldehyde and formaldehyde and have a high-stability high-strength six-membered cyclic acetal structure, thus, a polymer substrate polymerized by the derivates has a high cohesive strength.

As an improvement of the gel electrolyte formula disclosed herein, the modified polyvinyl alcohol and the derivates thereof refer to polyvinyl alcohol modified by a double-bonded silane coupling agent and the derivates thereof.

As an improvement of the gel electrolyte formula disclosed herein, the modified polyvinyl alcohol and the derivates thereof are prepared in the following way: prepare a mixed solvent with water and ethanol in a mass ratio of (1-9):(9-1), heat the mixed solvent while stirring the mixed solvent, add polyvinyl alcohol or a derivate thereof which accounts for 5-30% by mass of the mixed solvent, slowly add a certain mass of a silane coupling agent until no oily polymer is separated out of the mixed solvent after polyvinyl alcohol or the derivate thereof is completely dissolved, and then filter, clean and purify the oily polymer to obtain a pure silane-modified polyvinyl alcohol or a derivate thereof.

The silane coupling agent is capable of apparently enhancing the interface binding force between the gel electrolyte and the surface of the cathode, the surface of the anode or the separator to inhibit the swelling of the battery during a cycle process. A dehydration-condensation reaction may occur between the hydrolyzed silane coupling agent and polyvinyl alcohol and the derivates thereof to obtain a double-bonded modified polyvinyl alcohol and the derivates thereof.

As an improvement of the gel electrolyte formula disclosed herein, the silane coupling agent includes at least one of γ-(methacryloxy)propyltrimethoxylsilane, vinyltriisopropoxysilane, vinyldibutoxymethylsilane and ethoxydimethylvinylsilane.

As an improvement of the gel electrolyte formula disclosed herein, the cross-linking agent includes at least one of diallycarbonate, trimethylolpropane triacrylate, polyoxyethylene diacrylate, dipentaerythritol pentaacrylate, N,N′-methylenebisacrylamide, N,N-dimethylacrylamide, diacetone acrylamide, divinyl benzene and crotonic acid, each of which contains two or more double bonds and has an excellent cross-linking effect.

As an improvement of the gel electrolyte formula disclosed herein, the initiator is at least one of azodiisobutyronitrile (AIBN), 2,2′-azobisisoheptonitrile, 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide and cumene peroxide.

The liquid electrolyte includes lithium salt, a non-aqueous organic solvent and an additive.

The lithium salt, the molar concentration of which is 0.85 mol/L to 1.3 mol/L, is selected from at least one of LiPF₆, LiBF₄, LiAsF₆, LiCIO₄, LiBOB (Lithium bis(oxalate)borate), LiDFOB (lithium difluoroborate), LiCF₃SO₃, LiC₄F₉SO₃, Li(CF₃SO₂)₂N and Li(C₂F₅SO₂)₂N.

The non-aqueous organic solvent includes at least one of carbonic ester, carboxylic ester, an etheric compound and an aromatic compound.

The carbonic ester includes a cyclic carbonate and a chain carbonate in a mass ratio of 3:1 to 1:10.

The cyclic carbonate is at least one of ethylene carbonate, propylene carbonate and 2,3-butylene carbonate, and the chain carbonate is at least one of dimethyl carbonate, diethyl carbonate, methyl ethyl carbonate, dipropyl carbonate, methyl propyl carbonate, methyl isopropyl carbonate, methyl butyl carbonate and butylene carbonate.

The carboxylic ester includes an unsubstituted carboxylic ester and a halogenated carboxylic ester. The unsubstituted carboxylic ester is selected from at least one of methyl formate, ethyl formate, n-propyl formate, isopropyl formate, methyl acetate, ethyl acetate, n-propyl acetate, isopropyl acetate, methyl propionate, ethyl propionate, methyl butyrate, ethyl butyrate, γ-butyrolactone, γ-valerolactone and caprolactone, and the halogenated carboxylic ester is selected from at least one of methyl fluoroformate, ethyl fluoroformate, methyl monofluoroacetate, methyl difluoroacetate, ethyl monofluoroacetate, ethyl difluoroacetate, ethyl trifluoroacetate, propyl flurorformate, 3-fluoropropionate, 3,3-methyl difluoropropionate, 3,3,3-methyl trifluoropropionate, 3-ethyl fluoropropionate, 3,3-ethyl difluoropropionate and 3,3,3-ethyl trifluoropropionate.

The etheric compound includes an unsubstituted etheric compound and a halogenated etheric compound, wherein the unsubstituted etheric compound is one or more of butyl oxide, dimethoxymethane, dimethoxyethane, diethoxymethane, diethoxyethane, tetrahydrofuran and di methyltetrahydrofuran, and the halogenated etheric compound is selected from monofluorodimethoxymethane, monofluorodimethoxyethane, monofluorodiethoxymethane and monofluorodiethoxyethane.

The aromatic compound is selected from methylbenzene, fluorobenzene, o-Fluorotoluene, trifluorotoluene, 4-fluorotoluene, p-fluoromethoxybenzene, o-fluoromethoxybenzene, o-bifluoromethoxybenzene, 1-fluoro-4-tert-butyl benzene and fluorobiphenyl.

The additive includes at least one of vinylene carbonate, vinyl ethylene carbonate, fluoroethylene carbonate and 1,3-propane suhone. The total weight of the additive is 1 wt %-10 wt % of the total mass of the liquid electrolyte.

The other purpose of the present invention is to provide a lithium-ion secondary battery comprising an electrolyte, a cathode, an anode and a separator spaced between the cathode and the anode, wherein the electrolyte is a gel electrolyte formed by initiating the formula disclosed herein with heat or light. Preferably, the formula is initialized with heat at a temperature of 45-85 degrees centigrade.

With respect to the prior art, by using a modified polyvinyl alcohol and the derivates thereof having a relatively large average molecular weight in the gel electrolyte of a lithium-ion secondary battery, the present invention meets basic electrochemical performances with superior mechanical strength, excellent cycle performance and high safety.

### DETAILED DESCRIPTION OF THE PREFERRED EMBODIMENTS

The present invention and the beneficial effects thereof are further described below in detail with reference to specific embodiments which are not to be construed as limiting the present invention.

### Embodiment 1

The gel electrolyte formula provided in the embodiment consists of 97.4% by weight of a liquid electrolyte, 1.7% by weight of a monomer, 0.3% by weight of a cross-linking agent and 0.6% by weight of an initiator,

wherein the monomer, which is polyvinyl alcohol having an average molecular weight of 9×10⁴ g/mol, is modified using γ-(methacryloxy)propyltrimethoxysilane, the cross-linking agent is trimethylolpropane triacrylate, the initiator is benzoyl peroxide, and the liquid electrolyte composed of EC:PC:DEC:LiPF₆:VC in a ratio of 25:35:25:12.5:2.5 is recorded as C1.

To prepare the gel electrolyte, polyvinyl alcohol having an average molecular weight of 9×10⁴ g/mol and a saponification degree of 75% is selected first, then water and ethanol are prepared into a mixture in a mass ratio of 1:9, the mixture is heated while being stirred, then the polyvinyl alcohol, which accounts for 10% by mass of the mixture of water and ethanol, is added and completely dissolved in the mixture, the obtained solution is heated while being stirred, a certain mass of γ-(methacryloxy)propyltrimethoxysilane is added slowly until no generated oily polymer is separated out from the mixture of water and ethanol, the polymer is filtered, cleaned and purified to obtain powder of a pure macromolecular polyvinyl alcohol monomer L1 modified by γ-(methacryloxy)propyltrimethoxysilane.

Raw materials are prepared with the liquid electrolyte C1, the macromolecular monomer L1 and trimethylolpropane triacrylate in a mass ratio of 97.4:1.7:0.3. 97.4 g liquid electrolyte C1 is heated at 50 degrees centigrade, then 1.7 g macromolecular monomer L1 is added until a completely clean and transparent solution is formed, the solution is cooled to room temperature, sequentially, 0.3 g trimethylolpropane triacrylate is added and stirred uniformly, then 0.6 g initiator BPO is added, the solution is continuously stirred until a clear solution is formed, the clear solution is placed still for further use, then a gel electrolyte precursor is obtained.

An anode sheet and a cathode sheet are prepared using the ordinary method, and then a separator is arranged between the cathode sheet and the anode sheet according to the ordinary battery winding procedure to prepare a cell, then the cell is baked to be injected with the electrolyte.

The gel electrolyte precursor is injected into the baked cell, the cell is placed still for 24 h after being sealed and then cold-pressed to guarantee that the whole film is completely infiltrated by the electrolyte, sequentially, the cell is baked for 5 h at 70 degrees centigrade at a pressure of 1 Mpa so that the initiator can initiate the polymerization reaction of the monomer to form a uniform gel, then a formation processing, a shaping processing and a degassing processing are conducted for the gel to obtain a shaped battery which is numbered S1.

### Embodiment 2

The gel electrolyte formula provided in the embodiment consists of 96% by weight of a liquid electrolyte, 2.9% by weight of a monomer, 0.1% by weight of a cross-linking agent and 1% by weight of an initiator,

wherein the monomer, which is polyvinyl butyral having an average molecular weight of 10×10⁴ g/mol, is modified by vinyltriisopropoxysilane, the cross-linking agent is polyoxyethylene diacrylate, the initiator is azodiisobutyronitrile, and the liquid electrolyte composed of EC:PC:DMC:LiBF₄:fluoroethylene carbonate in a ratio of 25:35:25:12.5:2.5 is recorded as C2.

To prepare the gel electrolyte, the polyvinyl butyral having an average molecular weight of 10×10⁴ g/mol is selected first, then water and ethanol are prepared into a mixture in a mass ratio of 2:8, the mixture is heated while being stirred, then the polyvinyl butyral, which accounts for 20% by mass of the mixture of water and ethanol, is added and completely dissolved in the mixture, the obtained solution is heated while being stirred, a certain mass of vinyltriisopropoxysilane is added slowly until no generated oily polymer is separated out from the mixture of water and ethanol, the polymer is filtered, cleaned and purified to obtain powder of a pure macromolecular polyvinyl butyral monomer L2 modified by vinyltriisopropoxysilane.

Raw materials are prepared with the liquid electrolyte C2, the macromolecular monomer L2 and polyoxyethylene diacrylate in a mass ratio of 96:2.9:0.1. 96 g liquid electrolyte C2 is heated at 50 degrees centigrade, then 2.9 g macromolecular monomer L2 is added until a completely clean and transparent solution is formed, the solution is cooled to room temperature, sequentially, 0.1 g polyoxyethylene diacrylate is added and stirred uniformly, 1 g initiator azodiisobutyronitrile is added, the solution is continuously stirred until a clear solution is formed, the clear solution is placed still for further use, then a gel electrolyte precursor is obtained.

An anode sheet and a cathode sheet are prepared using the normal method, and then a separator is arranged between the cathode sheet and the anode sheet according to the ordinary battery lamination procedure to prepare a cell, then the cell is baked to be injected with the electrolyte.

The gel electrolyte precursor is injected into the baked cell, the cell is placed still for 24 h after being sealed and then cold-pressed to guarantee that the whole film is completely infiltrated by the electrolyte, sequentially, the cell is baked for 5 h at 80 degrees centigrade at a pressure of 0.5 Mpa so that the initiator can initiate the polymerization reaction of the monomer to form a uniform gel, then a formation processing, a shaping processing and a degassing processing are conducted for the gel to obtain a shaped battery which is numbered S2.

### Embodiment 3

The gel electrolyte formula provided in the embodiment consists of 99% by weight of a liquid electrolyte, 0.7% by weight of a monomer, 0.5%0 by weight of a cross-linking agent and 0.25% by weight of an initiator,

wherein the monomer, which is polyvinyl acetal having an average molecular weight of 7×10⁴ g/mol, is modified by vinyldibutoxymethylsilane, the cross-linking agent is dipentaerythritol pentaacrylate, the initiator is 2,2′-azobis-(2-methylbutyronitrile), and the liquid electrolyte composed of EC:PC:DMC:LiBF₄:PS in a ratio of 25:35:25:12.5:2.5 is recorded as C3.

To prepare the gel electrolyte, the polyvinyl acetal having an average molecular weight of 7×10⁴ g/mol is selected first, then water and ethanol are prepared into a mixture in a mass ratio of 3:7, the mixture is heated while being stirred, then the polyvinyl acetal, which accounts for 15% by mass of the mixture of water and ethanol, is added and completely dissolved in the mixture, a certain mass of vinyldibutoxymethylsilane is added slowly until no generated oily polymer is separated out from the mixture of water and ethanol, the polymer is filtered, cleaned and purified to obtain powder of a pure macromolecular polyvinyl acetal monomer L3 modified by vinyldibutoxymethylsilane.

Raw materials are prepared with the liquid electrolyte C3, the macromolecular monomer L3 and dipentaerythritol pentaacrylate in a mass ratio of 99:0.7:0.05. 99 g liquid electrolyte C3 is heated at 50 degrees centigrade, then 0.7 g macromolecular monomer L3 is added until a completely clean and transparent solution is formed, the solution is cooled to room temperature, sequentially, 0.05 g dipentaerythritol pentaacrylate is added and stirred uniformly, 0.25 g initiator 2,2′azobis-(2-methylbutyronitrile) is added, the solution is continuously stirred until a clear solution is formed, the clear solution is placed still for further use, then a gel electrolyte precursor is obtained.

An anode sheet and a cathode sheet are prepared using the normal method, and then a separator is arranged between the cathode sheet and the anode sheet according to the ordinary battery lamination procedure to prepare a cell, then the cell is baked to be injected with the electrolyte.

The gel electrolyte precursor is injected into the baked cell, the cell is placed still for 24 h after being sealed and then cold-pressed to guarantee that the whole film is completely infiltrated by the electrolyte, sequentially, the cell is baked for 5 h at 50 degrees centigrade at a pressure of 1.2 Mpa so that the initiator can initiate the polymerization reaction of the monomer to form a uniform gel, then a formation processing, a shaping processing and a degassing processing are conducted for the gel to obtain a shaped battery which is numbered S3.

### Embodiment 4

The gel electrolyte formula provided in the embodiment consists of 95.3% by weight of a liquid electrolyte, 3% by weight of a monomer, 0.2% by weight of a cross-linking agent and 1.5% by weight of an initiator,

wherein the monomer, which is polyvinyl formal having an average molecular weight of 15×10⁴ g/mol, is modified by ethoxydimethylvinylsilane, the cross-linking agent is N,N′-methylenebisacrylamide, the initiator is 2,2′-azobisisoheptonitrile, and the liquid electrolyte composed of EC:PC:DMC:LiBF₄:FEC in a ratio of 25:35:25:12.5:2.5 is recorded as C4.

To prepare the gel electrolyte, the polyvinyl formal having an average molecular weight of 15×10⁴ g/mol is selected first, then water and ethanol are prepared into a mixture in a mass ratio of 4:6, the mixture is heated while being stirred, then the polyvinyl formal, which accounts for 5% by mass of the mixture of water and ethanol, is added and completely dissolved in the mixture, a certain mass of ethoxydimethylvinylsilane is added slowly until no generated oily polymer is separated out from the mixture of water and ethanol, the polymer is filtered, cleaned and purified to obtain powder of a pure macromolecular polyvinyl formal monomer L4 modified by ethoxydimethylvinylsilane.

Raw materials are prepared with the liquid electrolyte C4, the macromolecular monomer L4 and N,N′-methylenebisacrylamide in a mass ratio of 95.3:3:0.2. 95.3 g liquid electrolyte C4 is heated at 50 degrees centigrade, then 3 g macromolecular monomer L4 is added until a completely clean and transparent solution is formed, the solution is cooled to room temperature, sequentially, 0.2 g N,N′-methylenebisacrylamide is added and stirred uniformly, 1.5 g initiator 2,2′-azobisisoheptonitrile is added, then the solution is continuously stirred until a clear solution is formed, the clear solution is placed still for further use, then a gel electrolyte precursor is obtained.

An anode sheet and a cathode sheet are prepared using the normal method, and then a separator is arranged between the cathode sheet and the anode sheet according to the ordinary battery lamination procedure to prepare a cell, then the cell is baked to be injected with the electrolyte.

The gel electrolyte precursor is injected into the baked cell, the cell is placed still for 24 h after being sealed and then cold-pressed to guarantee that the whole film is completely infiltrated by the electrolyte, sequentially, the cell is baked for 5 h at 60 degrees centigrade at a pressure of 0.1 Mpa so that the initiator can initiate the polymerization reaction of the monomer to form a uniform gel, then a formation processing, a shaping processing and a degassing processing are conducted for the gel to obtain a shaped battery which is numbered S4.

### Embodiment 5

The gel electrolyte formula provided in the embodiment consists of 98% by weight of a liquid electrolyte, 1% by weight of a monomer, 0.6% by weight of a cross-linking agent and 0.4% by weight of an initiator,

wherein the monomer, which is polyvinyl butyral having an average molecular weight of 15×10⁴ g/mol, is modified by ethoxydimethylvinylsilane and vinyltriisopropoxysilane, the cross-linking agent is the mixture of N,N-dimethylacrylamide and diacetone acrylamide (in a mass ratio of 1:2), the initiator is dodecamoyl peroxide, the liquid electrolyte composed of EC:PC:DMC:LiPF₆:FEC in a ratio of 25:35:25:12.5:2.5 is recorded as C5.

To prepare the gel electrolyte, the polyvinyl butyral having an average molecular weight of 15×10⁴ g/mol is selected first, then water and ethanol are prepared into a mixture in a mass ratio of 5:5, the mixture is heated while being stirred, then the polyvinyl butyral, which accounts for 20% by mass of the mixture of water and ethanol, is added and completely dissolved in the mixture, a certain mass of the mixture of ethoxydimethylvinylsilane and vinyltriisopropoxysilane (in a mass ratio of 1:1) is added slowly until no generated oily polymer is separated out from the mixture of water and ethanol, the polymer is filtered, cleaned and purified to obtain powder of a pure macromolecular polyvinyl butyral monomer L5 modified by silane.

Raw materials are prepared with the liquid electrolyte C4, the macromolecular monomer L4 and the mixture of N,N-dimethylacrylamide and diacetone acrylamide in a mass ratio of 98:1:0.6. 98 g liquid electrolyte C5 is heated at 50 degrees centigrade, then 1 g macromolecular monomer L5 is added until a completely clean and transparent solution is formed, the solution is cooled to room temperature, sequentially, 0.2 g N,N-dimethylacrylamide and 0.4 g diacetone acrylamide are added and stirred uniformly, 0.4 g initiator dodecamoyl peroxide is added, the solution is continuously stirred until a clear solution is formed, and the clear solution is placed still for further use, then a gel electrolyte precursor is obtained.

An anode sheet and a cathode sheet are prepared using the normal method, and then a separator is arranged between the cathode sheet and the anode sheet according to the ordinary battery lamination procedure to prepare a cell, then the cell is baked to be injected with the electrolyte.

The gel electrolyte precursor is injected into the baked cell, the cell is placed still for 24 h after being sealed and then cold-pressed to guarantee that the whole film is completely infiltrated by the electrolyte, sequentially, the cell is baked for 5 h at 85 degrees centigrade at a pressure of 0.7 Mpa so that the initiator can initiate the polymerization reaction of the monomer to form a uniform gel, then a formation processing, a shaping processing and a degassing processing are conducted for the gel to obtain a shaped battery which is numbered S5.

### Embodiment 6

The gel electrolyte formula provided in the embodiment consists of 96.7 by weight of a liquid electrolyte, 2.25% by weight of a monomer, 0.3% by weight of a cross-linking agent and 0.75% by weight of an initiator,

wherein the monomer, which is polyvinyl formal having an average molecular weight of 8×10⁴ g/mol, is modified by ethoxydimethylvinylsilane, the cross-linking agent is divinyl benzene, the initiator is the mixture of cumene peroxide and isobutyryl peroxide (in a mass ratio of 1:4), and the liquid electrolyte composed of EC:γ-BL:DEC:LiBF₄:VC in a ratio of 25:35:25:12.5:2.5 is recorded as C6.

To prepare the gel electrolyte, the polyvinyl formal having an average molecular weight of 8×10⁴ g/mol is selected first, then water and ethanol are prepared into a mixture in a mass ratio of 9:1, the mixture is heated while being stirred, then the polyvinyl formal, which accounts for 25% by mass of the mixture of water and ethanol, is added and completely dissolved in the mixture, a certain mass of ethoxydimethylvinylsilane is added slowly until no generated oily polymer is separated out from the mixture of water and ethanol, the polymer is filtered, cleaned and purified to obtain powder of a pure macromolecular polyvinyl formal monomer L6 modified by ethoxydimethylvinylsilane.

Raw materials are prepared with the liquid electrolyte C6, the macromolecular monomer L6 and divinyl benzene in a mass ratio of 95:2.2:0.3. 96.7 g liquid electrolyte C6 is heated at 50 degrees centigrade, then 2.25 g macromolecular monomer L6 is added until a completely clean and transparent solution is formed, the solution is cooled to room temperature, sequentially, 0.3 g divinyl benzene is added and stirred uniformly, 0.15 g cumene peroxide and 0.6 g isobutyryl peroxide are added, the solution is continuously stirred until a clear solution is formed, and the clear solution is placed still for further use, then a gel electrolyte precursor is obtained.

An anode sheet and a cathode sheet are prepared using the normal method, and then a separator is arranged between the cathode sheet and the anode sheet according to the ordinary battery lamination procedure to prepare a cell, then the cell is baked to be injected with the electrolyte.

The gel electrolyte precursor is injected into the baked cell, the cell is placed still for 24 h after being sealed and then cold-pressed to guarantee that the whole film is completely infiltrated by the electrolyte, sequentially, the cell is baked for 5 h at 45 degrees centigrade at a pressure of 1 Mpa so that the initiator can initiate the polymerization reaction of the monomer to form a uniform gel, then a formation processing, a shaping processing and a degassing processing are conducted for the gel to obtain a shaped battery which is numbered S6.

Comparative Sample 1

Comparative example 1 is merely different from embodiment 1 in that the monomer is glycidyl methacrylate and the finally obtained battery is numbered B1, and the other content of the comparative example is the same as that of embodiment 1 and is therefore not described repeatedly here.

The following performance tests are conducted for the batteries S1-S6 and B1.

Impact test: take 10 batteries from each of the battery groups S1-S6 and B1, fully charge the batteries and fix the batteries on a nail fixture, then conduct an impact test for the batteries by reference to the UL1642 test standard, the result is shown in the following Table T1.

Nail test: fully charge batteries S1-56 and B1, fix the batteries on a nail fixture, make the nail fixture penetrate the center of the batteries at a speed of 10 mm/s using an iron nail having a diameter of 2.5 mm, then count up the number of burning batteries, meanwhile, monitor the temperature rise curve of the nail penetration position and record the maximum value Tmax in the temperature rise curve, the result is shown in the following Table 1.

Cycle performance test: place the batteries still for 5 min, charge the batteries at a constant current rate of 0.5 C until the voltage is 4.2V, continue to charge the batteries with a constant voltage until the rate is reduced to 0.05C, place the batteries still for 5 min, discharge the batteries with a constant current rate of 0.5 C until the voltage is 3.0V to obtain an initial discharge capacity D0 (mAh), place the batteries still 3 min, charge the batteries at constant current rate of 0.5 C until the voltage is 4.2V, record the thickness of the barriers as T1, place the batteries still for 3 min, discharge the batteries at a rate of 0.5 C until the voltage is 3.0V, record the discharge capacity as D1, repeat this process for 500 times to obtain a final discharge capacity D500 (mAh), calculate the capacity retention ratio of the batteries after 500 times of cycle by dividing D500 by D1, record the thickness of the fully charged batteries as T500 and calculate the thickness swelling rate of the batteries after 500 times of cycle according to a formula: (T500/T1)−1), the result is shown in the following table T1.

TABLE 1
Result of performance tests on batteries S1-S6 and B1

| | | | | The | |
|---|---|---|---|---|---|
| | | | Thickness | number of | |
| | Initial | Capacity | swelling rate | the | |
| | discharge | retention ratio | after 500 | batteries | Tmax |
| Battery | D0 | after 500 | times of | passing | (° C.) in |
| No. | (mAh) | times of cycle | cycle | impact test | nail test |
| B1 | 1620 | 0.8126 | 9.2% | 3 | 118 |
| S1 | 1650 | 0.8621 | 6.9% | 6 | 106 |
| S2 | 1666 | 0.8813 | 6.0% | 10 | 86 |
| S3 | 1671 | 0.9103 | 4.6% | 10 | 91 |
| S4 | 1681 | 0.9078 | 5.3% | 8 | 94 |
| S5 | 1675 | 0.9113 | 5.8% | 8 | 97 |
| S6 | 1695 | 0.9221 | 6.7% | 7 | 100 |

It can be seen from Table 1 that compared with battery B1, batteries S1-S6 are higher in capacity retention ratio and lower in thickness swelling rate, are more likely to pass the impact test and less increased in temperature in the nail test as the batteries S1-S6 are improved in capacity performance, cycle performance and safety for the use of a monomer having a relatively molecular weight in the present invention which endows the formed gel electrolyte with a relatively high cohesive strength and endows the batteries with an excellent mechanical strength as well as basic electrochemical performance.

Proper variations and modifications can be devised by those skilled in the art on the aforementioned embodiments according to the disclosure and teaching of the present invention. Thus, the present invention is not limited to the specific embodiments disclosed and described above, and the modifications and variations devised should fall into the protection scope of the appending claims. In addition, the terms, as used herein, are merely illustrative of, but are not to be construed as limiting the present invention.

What is claimed is:

1. A gel electrolyte formula, comprising:
90-99.4% by weight of a liquid electrolyte;
0.5-3% by weight of a monomer;
0.25%0-0.6% by weight of a cross-linking agent, and
0.1-1.5% by weight of an initiator,
wherein the monomer is modified polyvinyl alcohol and the derivates thereof, the average molecular weight of which is 5×10⁴ to 15×10⁴ g/mol.

2. The gel electrolyte formula according to claim 1, wherein the average molecular weight of the modified polyvinyl alcohol and the derivates thereof is 8×10⁴ g/mol to 12×10⁴ g/mol.

3. The gel electrolyte formula according to claim 1, wherein the derivates include at least one of polyvinyl acetal, polyvinyl butyral and polyvinyl formal.

4. The gel electrolyte formula according to claim 1, wherein the modified polyvinyl alcohol and the derivates thereof refer to polyvinyl alcohol modified by a double-bonded silane coupling agent and the derivates thereof.

5. The gel electrolyte formula according to claim 4, wherein the modified polyvinyl alcohol and the derivates thereof are prepared by preparing a mixed solvent with water and ethanol in a mass ratio of (1-9):(9-1), heating the mixed solvent while stirring the mixed solvent, adding polyvinyl alcohol or a derivate thereof which accounts for 5-30% by mass of the mixed solvent, adding the silane coupling agent after the polyvinyl alcohol or the derivate thereof are completely dissolved until no oily polymer is separated out from the mixed solvent, and then filtering, cleaning and purifying the oily polymer to obtain a pure silane-modified polyvinyl alcohol or a derivate thereof.

6. The gel electrolyte formula according to claim 1, wherein the silane coupling agent includes at least one of γ-(methacryloxy)propyltrimethoxysilane, vinyltriisopropoxysilane, vinyldibutoxymethylsilane and ethoxydimethylvinylsilane.

7. The gel electrolyte formula according to claim 1, wherein the cross-linking agent includes at least one of diallycarbonate, trimethylolpropane triacrylate, polyoxyethylene diacrylate, dipentaerythritol pentaacrylate, N,N′-methylenebisacrylamide, N,N-dimethylacrylamide, diacetone acrylamide, divinyl benzene and crotonic acid.

8. The gel electrolyte formula according to claim 1, wherein the initiator is at least one of azodiisobutyronitrile (AIBN), 2,2′-azobisisoheptonitrile, 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide and cumene peroxide.

9. The gel electrolyte formula according to claim 1, wherein the weight percent of each of the components is as follows:
the liquid electrolyte: 93%-98%;
the monomer: 1%-2%;
the cross-linking agent: 0.75%0-0.4%; and
the initiator: 0.2%-1%.

10. The gel electrolyte formula according to claim 9, wherein the average molecular weight of the modified polyvinyl alcohol and the derivates thereof is 8×10⁴ g/mol to 12×10⁴ g/mol.

11. The gel electrolyte formula according to claim 9, wherein the derivates include at least one of polyvinyl acetal, polyvinyl butyral and polyvinyl formal.

12. The gel electrolyte formula according to claim 9, wherein the modified polyvinyl alcohol and the derivates thereof refer to polyvinyl alcohol modified by a double-bonded silane coupling agent and the derivates thereof.

13. The gel electrolyte formula according to claim 12, wherein the modified polyvinyl alcohol and the derivates thereof are prepared by preparing a mixed solvent with water and ethanol in a mass ratio of (1-9):(9-1), heating the mixed solvent while stirring the mixed solvent, adding polyvinyl alcohol or a derivate thereof which accounts for 5-30% by mass of the mixed solvent, adding the silane coupling agent after the polyvinyl alcohol or the derivate thereof are completely dissolved until no oily polymer is separated out from the mixed solvent, and then filtering, cleaning and purifying the oily polymer to obtain a pure silane-modified polyvinyl alcohol or a derivate thereof.

14. The gel electrolyte formula according to claim 9, wherein the silane coupling agent includes at least one of γ-(methacryloxy)propyltrimethoxysilane, vinyltriisopropoxysilane, vinyldibutoxymethylsilane and ethoxydimethylvinylsilane.

15. The gel electrolyte formula according to claim 9, wherein the cross-linking agent includes at least one of diallycarbonate, trimethylolpropane triacrylate, polyoxyethylene diacrylate, dipentaerythritol pentaacrylate, N,N′-methylenebisacrylamide, N,N-dimethylacrylamide, diacetone acrylamide, divinyl benzene and crotonic acid.

16. The gel electrolyte formula according to claim 9, wherein the initiator is at least one of azodiisobutyronitrile (AIBN), 2,2′-azobisisoheptonitrile, 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide and cumene peroxide.

17. A lithium-ion secondary battery comprising an electrolyte, a cathode, an anode and a separator between the cathode and the anode, wherein the electrolyte is a gel electrolyte formed by initiating the formula claimed in claim 1 with heat or light.

18. A lithium-ion secondary battery comprising an electrolyte, a cathode, an anode and a separator between the cathode and the anode, wherein the electrolyte is a gel electrolyte formed by initiating the formula claimed in claim 9 with heat or light.
